(19) United States
(12) Patent Application Publication
(10) Pub. No.: US 2014/0379178 A1
(43) Pub. Date: Dec. 25, 2014

(54) SYSTEM AND METHOD FOR FINE POSITIONING OF VTOL STARE POINT

(71) Applicant: Honeywell International Inc., Morristown, NJ (US)

(72) Inventors: Emray Rein Goossen, Albuquerque, NM (US); Katherine Goossen, Albuquerque, NM (US)

(21) Appl. No.: 13/925,028

(22) Filed: Jun. 24, 2013

(51) Int. Cl. B64C 29/00

(52) U.S. Cl. CPC B64C 29/0091
USPC 701/15

(57) ABSTRACT

A method for fine positioning of a vertical takeoff and landing (VTOL) vehicle comprises: receiving a command to execute a bump, wherein a bump is a movement of the vehicle by a bump distance in a singular direction, wherein the bump distance is a pre-determined distance moved by the vehicle in a bump; generating a control signal based on the command to execute a bump, wherein the control signal causes a vertical takeoff and landing (VTOL) vehicle to move a bump distance.

### BACKGROUND

One of the advantages a vertical takeoff and landing (VTOL) unmanned aerial vehicle (UAV) has over a fixed wing UAV is its ability to perch and stare and its ability to hover and stare. From those positions it is common to have a sensor mounted on a mechanical gimbal giving the system or the operator the ability to manually or autonomously command azimuth and elevation of the sensor towards the desired target. In most cases, the gimbaled camera makes it easy to position the VTOL UAV into a stare position and utilize the gimbal for fine positioning. However, there are cases in which the line of sight has a tunnel effect, such as a view through trees into a window, requiring precise positioning of the vehicle before the gimbal can even be used.

### SUMMARY

In one embodiment, a method for fine positioning of a vertical takeoff and landing (VTOL) vehicle is provided. The method comprises receiving a command to execute a bump, wherein a bump is a movement of the vehicle by a bump distance in a singular direction, wherein the bump distance is a pre-determined distance moved by the vehicle in a bump, and generating a control signal based on the command to execute a bump, wherein the control signal causes a vertical takeoff and landing (VTOL) vehicle to move a bump distance.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of a method for fine positioning of a vertical takeoff and landing vehicle;

FIG. 2 is a block diagram of an example system for fine positioning a vertical takeoff and landing vehicle;

FIG. 3 is a block diagram illustrating an example inertial control stick as a user interface device;

FIG. 4 is illustrates an exemplary display on a user interface for use with a system for fine positioning a vertical takeoff and landing vehicle;

FIG. 5A illustrates an exemplary altitude bump command input to a position control system loops;

FIG. 5B illustrates an exemplary heading bump command input to a position control system loop;

5C illustrates an exemplary lateral position bump command input to a position control system loops.

### DETAILED DESCRIPTION

The subject matter described herein includes a VTOL vehicle configured to implement a bump. When manually controlled, the VTOL UAV can be positioned in the sighting area with common control means (common remotely piloted vehicle (RPV) control sticks, levers, stylus on a touchscreen, or inertial control stick, etc). Then, a bump function is employed in which the operator commands a prescribed distance, direction, altitude, and/or heading such that the onboard navigation systems makes small adjustments according to its positioning sensors (such as; inertial, magnetometer, GPS, optical features). A bump function can be implemented as a button click or tap in the RPV controls that moves the vehicle a prescribed distance in that direction. The prescribed distance may be adjusted by a value entry, slider, or other means by the operator at flight time. The prescribed distance may also have a manufacturer recommended setting.

When under autonomous control the autonomous control may bring the vehicle to the sighting area and give manual control to the operator or the autonomous system can also use the bump methodology in an autonomous fashion to obtain clear line of sight to the target. The clear line of sight may be sourced from a target recognition sensor system.

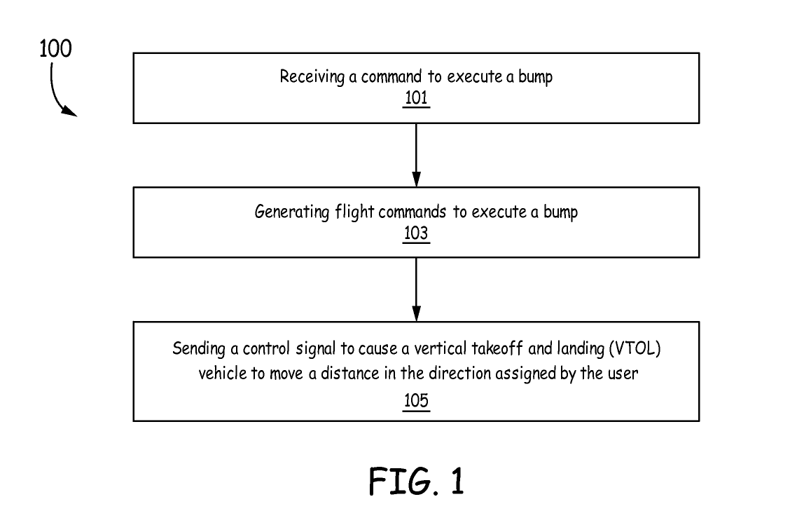

FIG. 1 is a block diagram illustrating an example method 100 for fine positioning of a VTOL vehicle. At block 101, a command to execute a bump is received. The bump function is initiated through a user through a user interface device. In some embodiments, this may be a control stick with a button or combination of buttons dedicated to the bump command. In other embodiments, this may be a hand or finger gesture on a hand and finger intuitive control stick, or a tap on a touch sensitive screen. It is to be understood that the bump function can be implemented in a variety of ways and is not limited to the embodiments discussed above. At block 103, a set of flight commands is generated to instruct the vehicle to execute the bump. Instructions to generate a bump in a chosen direction, for example in the up, down, left, right, forward, or backward directions, are stored in onboard memory. At block 105, the flight commands are turned into a control signal that causes the vehicle to move a pre-determined “bump” distance. In one embodiment, the bump distance is coded into the onboard memory of the vehicle as a static value. The bump distance is consistent with every bump and cannot be changed. In other embodiments, the bump distance may be set by the user. In some implementations of such embodiments, bump distances may be limited to a range of distances for the user to pick from. The bump is a singular movement in a single direction, that is, it is one movement in one direction.

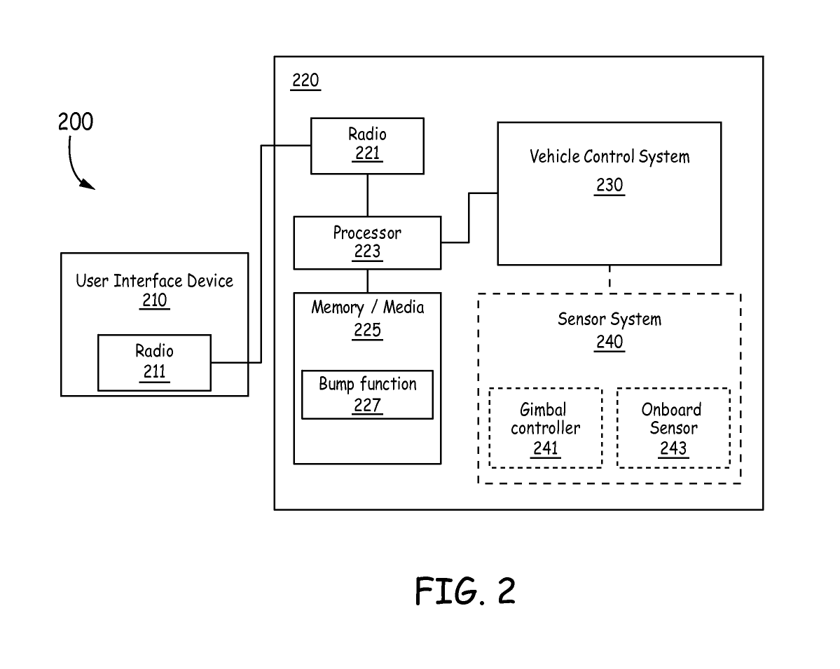

FIG. 2 is a block diagram of an example system 200 for fine positioning of a VTOL vehicle. User interface device 210 is coupled to VTOL 220. In one embodiment, the user interface device 210 is a RPV intuitive control stick. In other embodiments, the user interface device is a hand and finger intuitive control stick, a stylus and touchscreen, or an inertial stick. It is to be understood the user interface device is not to be limited to the above mentioned embodiments, and that other alternatives known to those in the art may be used as well. User interface device 210 includes a radio 211. Radio 211 is configured to communicate with radio 221 on board the VTOL 220. Radio 221 is coupled to processor 223. Processor 223 is coupled to system memory or computer readable media 225. System memory 225 includes instructions for a bump function 227. When the instructions for a bump function 227 are executed by the processor 223, processor 223 generates flight commands for the vehicle to execute a bump. Processor 223 is coupled to vehicle control system 230, to which the processor sends the control signal. The flight commands are translated into a control signal by vehicle control system 230 causing the vehicle move a bump distance. In one embodiment, the bump distance is configured as a static value as part of the bump function. In other embodiments, the bump distance can be set by a user through the user interface device 210. In one embodiment, the vehicle control system 230 is optionally coupled to sensor system 240. Sensor system 240 includes gimbal controller 241 and onboard sensor 243. In one embodiment, onboard sensor 243 is an optical sensor, such as a camera. In other embodiments, the onboard sensor 243 is an electro-optical/infrared (EO/IR) sensor. It is to be understood that the onboard sensor is not to be limited by the above mentioned embodiments, and that other alternative onboard sensors known to those having ordinary skill in the art may be substituted in other embodiments. The onboard sensor 243 is placed on a gimbal, which is configured to be positioned by gimbal controller 241. In one embodiment, the gimbal controller is configured to keep onboard sensor 243 focused on an object of interest. This may include re-positioning the onboard sensor after the vehicle 220 performs a bump.

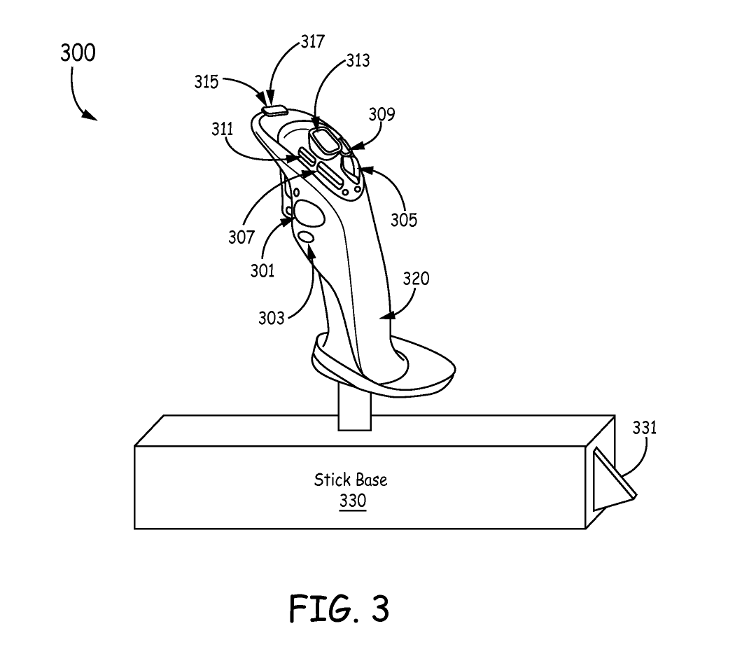

FIG. 3 is an example user interface device 210, in the form of an inertial control stick 300. Inertial control stick 300 includes buttons for throttle/hold and bump override 301; manual mode/release 303; bump mode/altitude hold mode 305; altitude bump down/heading reference set 307; launch/land 309; altitude bump up 311; and a top-hat control for gimbal positioning/lateral position bump 313. The inertial control stick also includes a mode indicator light emitting diode (LED) 315, and warning LED 317. The inertial control stick is also configured to include a vibration alert 320. The inertial control stick is coupled to stick base 330. Stick base 330 includes on/off switch 331 and a radio transmitter.

FIG. 3 illustrates functionality for inertial control stick 300 providing four modes of flight; 1) robust manual guidance of a VTOL vehicle, 2) VTOL autonomous position, altitude, and heading hold from at the operator release point, 3) Sensor positioning gimbal control, and 4) fine positioning control.

When the operator grips the stick with his thumb on the Manual/Release button 303 the system is in “Rapid Maneuvering Control (RMC) Mode” giving the operator full inertial control of the VTOL vehicle as it will follow his hand motions autonomously.

The “Rapid Maneuvering Control Mode with Altitude Hold (RMCAH) Mode” is a submode in which the vehicle follows the operators hand motion in lateral movements,

When the operator removes his thumb from the Manual/Release button 303 the VTOL vehicle enters the “VTOL Position, Altitude, Heading Hold (PAHH) Mode” in which the vehicle will utilize the on-board sensors to maintain current position, current altitude, and current heading at the time of the release.

When the VTOL vehicle is in “Position, Altitude, Heading Hold Mode”, operator actions on the top-hat button 313 activate the “Manual Sensor Positioning Gimbal Control (MSPGC) Mode”. Forward motions on the top-hat 313 control the gimbal elevation angle. Side motions on the top-hat 313 control the gimbal azimuth position relative to the vehicle.

A “Sensor Feature Hold (SFH) Mode” can also be activated while in the “Position, Altitude, Heading Hold Mode” providing autonomous sensor gimbal steering while in the “Position, Altitude, Heading Hold Mode” and entry back into the “Rapid Maneuvering Control Mode”. The “Sensor Feature Hold Mode” will stay active in the “Rapid Maneuvering Control Mode” as long as the sensor hold mode is able to maintain the feature within its Field of Regard (FOR).

When the VTOL vehicle is in “Position, Altitude, Heading Hold Mode”, the operator can select the “Fine 3D VTOL Positioning (F3DP) Mode” in order to precisely locate the VTOL vehicle in altitude, lateral, vertical, and heading position so as to provide optimum visibility through the on-board surveillance sensors.

In one embodiment, the transitions between control submodes are through operation of the buttons. “Launch” 309 enters manual mode. From manual mode, “Altitude Hold” 305 enters Altitude Hold mode. From manual mode or Altitude Hold “Release” 303 enters Altitude/Position Hold modes. From Altitude/Position Hold, “Bump” 305 enters Position Bump. From Bump Mode, “Bump” 305 exits Position Bump into Altitude/Position Hold. From Position Hold or Position Bump, “Manual” 303 enters Manual with Altitude Hold. From Manual Altitude Hold, “Throttle” 301 enters

Full Manual mode where depressing the Manual/Release button 303 enters Manual mode, and Manual/Release 303 not being depressed goes to Release. Sensor positioning control transitions between Manual Sensor Positioning Gimbal Control (MSPGC) and Sensor Feature Hold (SFH) Mode can only be made while in the vehicle VTOL Position, Altitude, Heading Hold (PAHH) Mode. This is because the feature selection system must be given a selected feature item to hold. Once the SFH mode is selected transitions into RMC and RMCAH modes retain SFH operation until either deselected or when the SFH function determines loss of capability due to loss of vehicle line of sight to the feature. Table 1 below illustrates the primary mode and sub mode interactions.

TABLE 1
Inertial control stick submodeswith bump functionality

| | | | | Release | |
|---|---|---|---|---|---|
| Primary Modes | Pre- | Manual | | PAHH | |
| Submodes | Launch | RMC | RMCAH | MSPGC | F3DP |
| Gimbal Positioning | | | | | |
| Azimuth Slew | | | | X | |
| Elevation Slew | | | | X | |
| Feature Hold (SFH) | | X | X | | X |
| Position Bump | | | | | |
| Altitude Bump | | | | | X |
| Lateral Bump | | | | | X |
| Longitudinal Bump | | | | | X |
| Throttle | | X | | | |
| Attitude by Tilt | | X | X | | |
| VTOL Control | Launch > | | | | |
| Transitions | | Alt Hold Mode > | | | |
| | | Release > | | | |
| | | | Release > | | |
| | | | | Bump Mode > | |
| | | | | < Bump Mode | |
| | | | < Manual | | |
| | | | < Manual | | |
| | | < Throttle | | | |
| Mode Indicator LED | Off | Off | On | On | Flashing |
| Sensor Positioning | | | | >MSPGC | |
| Transions | | | | | >SFH |

SFH<

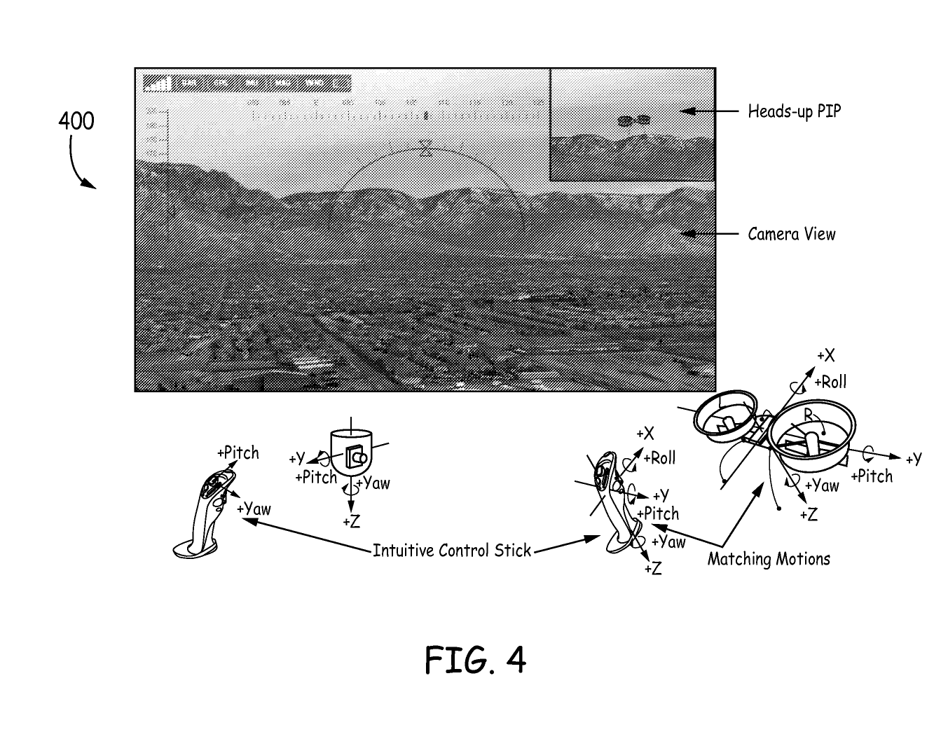

FIG. 4 illustrates an exemplary camera view 400 from a gimbaled optical sensor on the vehicle. Control input from an inertial control stick is illustrated along with corresponding VTOL motions.

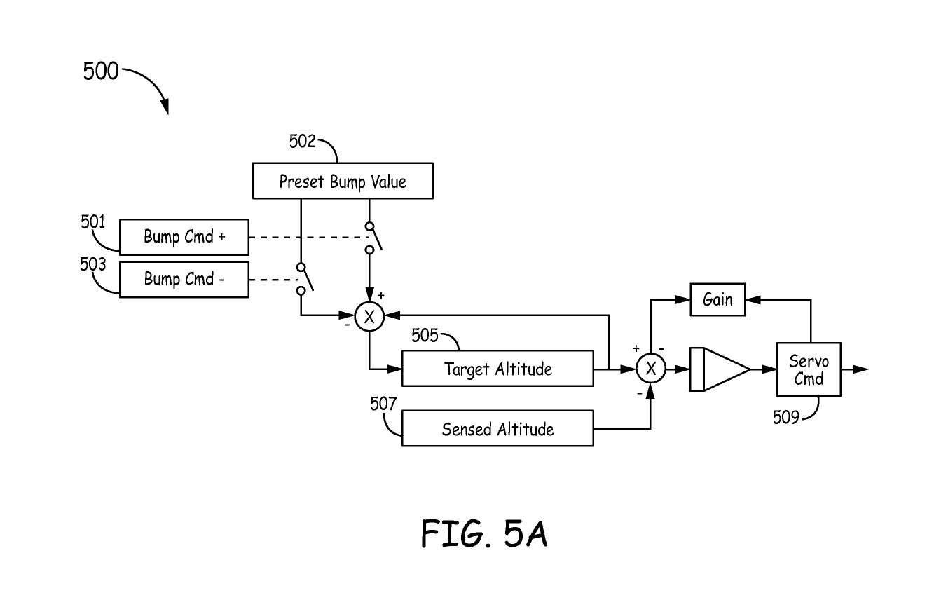

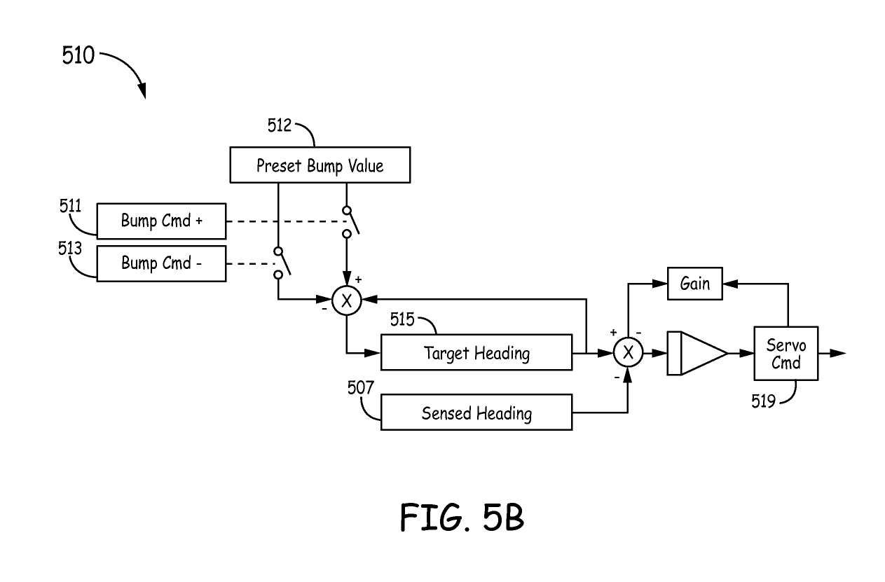

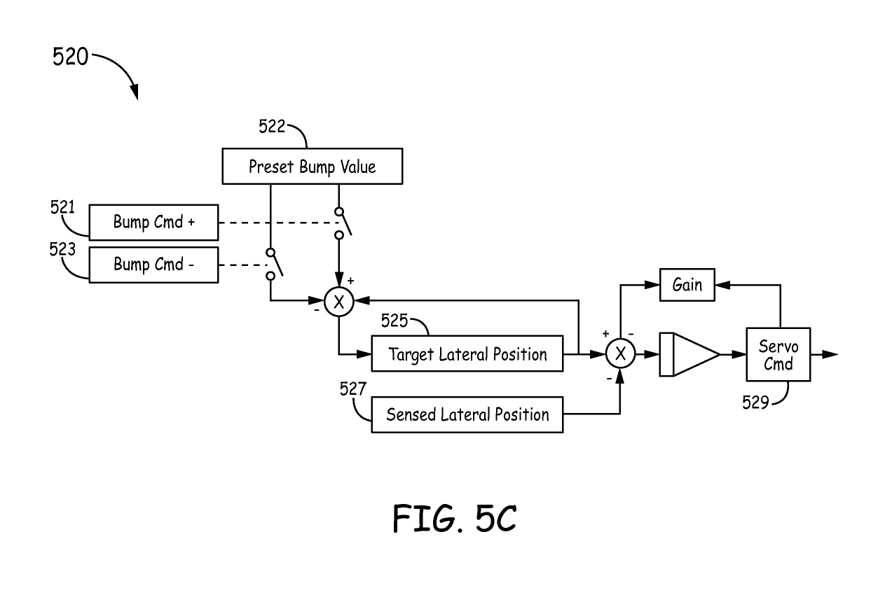

FIG. 5 illustrates the fine positioning bump interfacing to the vehicle control system closed loops 500, 510, and 520. The basic control loop and bump interfacing is the same for all 4 positioning loops; altitude, heading, and longitude/latitude lateral positioning. A preset bump value 503, 513, 523 is either added to 501, 511, 521 or subtracted from 503, 513, 523 the last target (altitude 505, heading 515, or position 525) becoming the current target value. The target (altitude 505, heading 515, or position 525) difference from the sensed value 507, 517, 527 generates the command signal to the vehicle servos 509, 519, 529 to move the vehicle.

### EXAMPLE EMBODIMENTS

Example 1 includes a method for fine positioning of a vertical takeoff and landing (VTOL) vehicle comprising: receiving a command to execute a bump, wherein a bump is a movement of the vehicle by a bump distance in a singular direction, wherein the bump distance is a pre-determined distance moved by the vehicle in a bump; generating a control signal based on the command to execute a bump, wherein the control signal causes a vertical takeoff and landing (VTOL) vehicle to move a bump distance.

Example 2 includes the method of example 1 wherein the bump distance is static.

Example 3 includes the method of example 1, wherein the bump distance is configurable by a user.

Example 4 includes the method of any of examples 2 and 3, wherein the bump distance is limited to a range from within which the user can select a bump distance.

Example 5 includes the method of any of examples 1-4 wherein the bump is an altitudinal movement of the vehicle.

Example 6 includes the method of any of examples 1-4, wherein the bump is one of a lateral movement of the vehicle or heading movement of the vehicle.

Example 7 is a system for fine positioning of a vertical takeoff and landing (VTOL) vehicle comprising: a user interface device including a first radio; a VTOL vehicle including: a second radio configured to communicate with the first radio;

a processor; a computer readable medium coupled to the processor, the computer readable medium including instructions to implement a bump function, wherein the bump function causes the microprocessor to: receive a command to execute a bump, wherein a bump is a movement of the vehicle by a bump distance in a singular direction, wherein the bump distance is a pre-determined distance moved by the vehicle in a bump; generate flight commands to execute a bump based on the command to execute a bump; and a vehicle control system coupled to the processor, wherein the vehicle control system controls the flight of the vehicle, wherein the vehicle control system generates a control signal based on the flight commands, wherein the control signal causes the vehicle to move a bump distance.

Example 8 includes the system of example 7, wherein the bump distance is static.

Example 9 includes the system of example 7, wherein the bump distance is configurable by a user.

Example 10 includes the system of any of example 7 and 9, wherein the bump distance is limited to a range from within which the user can select a bump distance.

Example 11 includes the system of any of examples 7-10, wherein the bump is an altitudinal movement of the vehicle.

Example 12 includes the system of any of examples 7-10, wherein the bump is one of a lateral movement of the vehicle or heading movement of the vehicle.

Example 13 includes the system of any of examples 7-12, wherein the user interface device is an inertial control stick.

Example 14 includes the system of any of examples 7-13, comprising a sensor system including: an onboard sensor, wherein the onboard sensor is mounted on a gimbal; and a gimbal controller.

Example 15 includes the system of any of examples 7-14, wherein the onboard sensor is an electro-optical/infrared (EO/IR) sensor.

Example 16 includes the system of any of examples 7-15, wherein the gimbal controller is configured to reposition the onboard sensor to keep an object of interest in view of the onboard sensor after the vehicle executes a bump.

Example 17 is an apparatus comprising: a user interface device, wherein the user interface device is configured to provide a vertical takeoff and landing (VTOL) vehicle with bump functionality, wherein a bump is a movement of the vehicle by a bump distance in a singular direction, wherein the bump distance is a pre-determined distance moved by the vehicle during a bump, the user interface device further comprising: a bump control, capable of generating a bump command, wherein the bump command causes the vehicle to execute a bump; a radio configured to communicate with the vehicle.

Example 18 includes the apparatus of example 17 wherein the bump distance is user configurable, the user interface device comprising a means for a user to select a bump distance.

Example 19 includes the apparatus of examples 17 and 18, wherein the user interface device is an inertial control stick.

Example 20 includes the apparatus of examples 17-19, wherein the user interface device is configured to send flight commands to the vehicle, wherein the flight commands cause a control system of a vehicle to generate control signals that cause the vehicle to move a bump distance.

What is claimed is:

1. A method for fine positioning of a vertical takeoff and landing (VTOL) vehicle comprising:
receiving a command to execute a bump, wherein a bump is a movement of the vehicle by a bump distance in a singular direction, wherein the bump distance is a pre-determined distance moved by the vehicle in a bump; and
generating a control signal based on the command to execute a bump, wherein the control signal causes a vertical takeoff and landing (VTOL) vehicle to move a bump distance.

2. The method of claim 1 wherein the bump distance is static.

3. The method of claim 1, wherein the bump distance is configurable by a user.

4. The method of claim 3, wherein the bump distance is limited to a range from within which the user can select a bump distance.

5. The method of claim 1 wherein the bump is an altitudinal movement of the vehicle.

6. The method of claim 1, wherein the bump is one of a lateral movement of the vehicle or heading movement of the vehicle.

7. A system for fine positioning of a vertical takeoff and landing (VTOL) vehicle comprising:
a user interface device including a first radio;
a VTOL vehicle including:
a second radio configured to communicate with the first radio;
a processor;
a computer readable medium coupled to the processor, the computer readable medium including instructions to implement a bump function, wherein the bump function causes the microprocessor to:
receive a command to execute a bump, wherein a bump is a movement of the vehicle by a bump distance in a singular direction, wherein the bump distance is a pre-determined distance moved by the vehicle in a bump;
generate flight commands to execute a bump based on the command to execute a bump; and
a vehicle control system coupled to the processor, wherein the vehicle control system controls the flight of the vehicle, wherein the vehicle control system generates a control signal based on the flight commands, wherein the control signal causes the vehicle to move a bump distance.

8. The system of claim 7, wherein the bump distance is static.

9. The system of claim 7, wherein the bump distance is configurable by a user.

10. The system of claim 9, wherein the bump distance is limited to a range from within which the user can select a bump distance.

11. The system of claim 7, wherein the bump is an altitudinal movement of the vehicle.

12. The system of claim 7, wherein the bump is one of a lateral movement of the vehicle or heading movement of the vehicle.

13. The system of claim 7, wherein the user interface device is an inertial control stick.

14. The system of claim 7, comprising a sensor system including:
an onboard sensor, wherein the onboard sensor is mounted on a gimbal; and
a gimbal controller.

15. The system of claim 14, wherein the onboard sensor is an electro-optical/infrared (EO/IR) sensor.

16. The system of claim 14, wherein the gimbal controller is configured to reposition the onboard sensor to keep an object of interest in view of the onboard sensor after the vehicle executes a bump.

17. An apparatus comprising:
a user interface device, wherein the user interface device is configured to provide a vertical takeoff and landing (VTOL) vehicle with bump functionality, wherein a bump is a movement of the vehicle by a bump distance in a singular direction, wherein the bump distance is a pre-determined distance moved by the vehicle during a bump, the user interface device further comprising:
a bump control, capable of generating a bump command, wherein the bump command causes the vehicle to execute a bump; and
a radio configured to communicate with the vehicle.

18. The apparatus of claim 17 wherein the bump distance is user configurable, the user interface device comprising a means for a user to select a bump distance.

19. The apparatus of claim 17, wherein the user interface device is an inertial control stick.

20. The apparatus of claim 17, wherein the user interface device is configured to send flight commands to the vehicle, wherein the flight commands cause a control system of a vehicle to generate control signals that cause the vehicle to move a bump distance.
